(19) United States
(12) Patent Application Publication
(10) Pub. No.: US 2022/0055021 A1
(43) Pub. Date: Feb. 24, 2022

(54) LAYERED THREE-WAY CONVERSION (TWC) CATALYST AND METHOD OF MANUFACURING THE CATALYST

(71) Applicant: BASF CORPORATION, Florham Park, NJ (US)

(72) Inventors: Fudong LIU, Orlando, FL (US); Michel DEEBA, East Brunswick, NJ (US); Ke-Bin LOW, Iselin, NJ (US)

(21) Appl. No.: 17/309,658

(22) PCT Filed: Dec. 12, 2019
(86) PCT No.: PCT/IB2019/060713

§ 371 Date: Jun. 14, 2021

Related U.S. Application Data
(60) Provisional application No. 62/779,037, filed on Dec. 13, 2018.

(30) Foreign Application Priority Data
Jan. 23, 2019 (EP) 19153168.0

(51) Int. Cl. B01J 23/58; B01J 21/04; B01J 21/06; B01J 23/10; B01J 23/44; B01J 23/00; B01J 37/04; B01J 37/08; B01J 37/02; B01J 37/03; B01J 35/00; B01J 35/04; B01D 53/94; F01N 3/28; F01N 3/10

(52) U.S. Cl. CPC B01J 23/58; F01N 2370/02; B01J 21/066; B01J 23/10; B01J 23/44; B01J 23/002; B01J 37/04; B01J 37/082; B01J 37/024; B01J 37/038; B01J 35/0006; B01J 35/0026; B01J 35/04; B01D 53/945; B01D 53/9468; B01D 53/9472; F01N 3/2803; F01N 3/101; B01D 2255/1023; B01D 2255/908; B01D 2255/2042; B01D 2255/1025; B01D 2255/9022; B01D 2255/407; B01D 2255/9032; B01J 21/04

(57) ABSTRACT

The presently claimed invention provides a layered three-way catalyst composition for purification of exhaust gases from internal combustion engines; said catalyst comprises a first layer comprising i) palladium supported on at least one alumina component and at least one oxygen storage component; and ii) barium oxide; wherein said first layer is essentially free of strontium, and a second layer comprising: i) rhodium supported on at least one zirconia component and/or alumina component; ii) strontium oxide and/or barium oxide; and iii) optionally, palladium supported on at least one alumina component. The presently claimed invention also provides a process for preparing the layered three-way catalyst composition which involves a technique such as incipient wetness impregnation technique(A); co-precipitation technique (B); or co-impregnation technique(C). The process includes preparing a first layer; preparing a second layer; and depositing the second layer on the first layer followed by calcination. The presently claimed invention further provides a a layered three-way catalytic article in which the three-way catalyst composition is deposited on a substrate in a layered fashion and its preparation.

### FIELD OF THE DISCLOSURE

The presently claimed invention relates to a layered catalyst composition useful for the treatment of the exhaust gases to reduce contaminants contained therein. Particularly, the presently claimed invention relates to the improved three-way conversion (TWC) catalysts and methods of preparing the catalysts.

### BACKGROUND

Three-way conversion (TWC) catalysts (hereinafter interchangeably referred to as three-way conversion catalyst, three-way catalyst, TWC Catalyst, and TWC) have been utilized in the treatment of the exhaust gas streams from the internal combustion engines for several years. Generally, in order to treat or purify the exhaust gas containing pollutants such as hydrocarbons, nitrogen oxide, and carbon monoxide, catalytic converters containing a three-way conversion catalyst are used in the exhaust gas line of an internal combustion engine. The three-way conversion catalyst is typically known to oxidize unburn hydrocarbon and carbon monoxide and reduce nitrogen oxide.

The TWC catalyst comprises one or more platinum group metals (hereinafter interchangeably referred to as PGM) such as platinum, palladium, rhodium, rhenium, and iridium deposited on a refractory metal oxide support such as alumina which is further carried on a carrier such as a monolithic carrier.

A large quantity of catalytic converters is required to be installed on vehicles each year which in-turn consumes a very large amount of PGM in gasoline emission control in order to meet the emission standards for unburned hydrocarbons, carbon monoxide and nitrogen oxide contaminants set by various governments. A similar situation also exists for diesel emission control using PGM components such as diesel oxidation catalysts (DOC), and indoor air pollution control such as volatile organic compound (VOC) elimination with increased demand of PGM usage especially in emerging Asia area.

Accordingly, there is still a need to improve the intrinsic activity of PGM catalysts in TWC application so that significantly less PGM can be used to achieve even more strict emission standards.

### SUMMARY OF THE DISCLOSURE

The presently claimed invention is directed to an enhancement of the PGM effectiveness by utilizing alkaline earth metal oxide promoters such as barium oxide (BaO) and strontium oxide (SrO) which are found to act as electronic modifiers in close contact with the PGM such as palladium (Pd) and rhodium (Rh). These promoters are found to improve the reducibility of the PGM under reaction conditions thereby promoting the catalytic performance. Thus, the TWC performance is greatly improved to meet tighter emission regulations without increasing the loading of precious metals such as palladium, platinum and rhodium.

Accordingly, in one aspect, the presently claimed invention provides a layered three-way catalyst composition for purification of the exhaust gases from the internal combustion engines. The catalyst composition is found to remove at least a portion of nitrogen oxide (NOx), carbon monoxide (CO), and hydrocarbon (HC) emissions from automotive exhaust. The catalyst composition is particularly useful in the gasoline internal combustion engine Three-Way Catalyst (TWC) applications. In one embodiment, the catalyst comprises a first layer comprising i) palladium supported on at least one alumina component and at least one oxygen storage component; and ii) barium oxide; wherein said first layer is essentially free of strontium, wherein the amount of strontium is less than 0.01%, and a second layer comprising rhodium supported on at least one zirconia component and/or alumina component; strontium oxide and/ or barium oxide; and optionally, palladium supported on at least one alumina component.

In one embodiment, the first layer is loaded with 5 to 200 g/ft³ (0.1766 to 7.062 kg/m³) of palladium supported on the alumina component and the oxygen storage component; and 0.01-0.4 g/in³ (0.610-24.40 kg/m³) of barium oxide. In one embodiment, the second layer is loaded with 0 to 80 g/ft³ (0 to 2.8251 kg/m³) of palladium supported on at least one alumina component, 0.2 to 30 g/ft³ (0.007 to 1.059 kg/m³) of rhodium supported on at least one zirconia or alumina component, and 0 to 0.2 g/in³ (0-12.20 kg/m³) of barium oxide or 0.01 to 0.2 g/in³ (0.610-12.20 kg/m³) of strontium oxide. In another embodiment, the layered three-way catalyst composition comprises a substrate, wherein the first layer or the second layer is deposited on the substrate.

In yet another embodiment, the catalyst composition exhibits zoned configuration in which the first and/or the second layer is configured into a first zone and a second zone.

In another aspect, the presently claimed invention provides a process for preparing the layered three-way catalyst composition of the presently claimed invention. The process includes preparing a first layer; optionally depositing the first layer on a substrate; preparing a second layer; and depositing the second layer on the first layer followed by calcination. The steps of preparing the first layer and the second layer involves a technique such as incipient wetness impregnation technique(A); co-precipitation technique (B); or co-impregnation technique(C).

In still another aspect, the presently claimed invention provides a method of treating a gaseous exhaust stream comprising hydrocarbons, carbon monoxide, and nitrogen oxide. The method comprises contacting said exhaust stream with the presently claimed catalyst composition or the catalyst composition obtained by the presently claimed process.

In yet another aspect, the presently claimed invention provides a method of reducing hydrocarbons, carbon monoxide, and nitrogen oxide levels in a gaseous exhaust stream. The method comprises contacting the gaseous exhaust stream with the presently claimed catalyst composition or the catalyst composition obtained by the presently claimed process to reduce the levels of hydrocarbons, carbon monoxide, and nitrogen oxide in the exhaust gas.

In a further aspect, the presently claimed invention provides an exhaust system for internal combustion engines comprising the three-way catalyst composition according to the presently claimed invention or the catalyst composition obtained by the presently claimed process, positioned downstream from an internal combustion engine in fluid communication with the exhaust gas stream and adapted for the abatement of CO and HC and conversion of NOx to N₂.

### BRIEF DESCRIPTION OF THE DRAWINGS

In order to provide an understanding of embodiments of the invention, reference is made to the appended drawings, which are not necessarily drawn to scale, and in which reference numerals refer to components of exemplary embodiments of the invention. The drawings are exemplary only and should not be construed as limiting the invention. The above and other features of the presently claimed invention, their nature, and various advantages will become more apparent upon consideration of the following detailed description, taken in conjunction with the accompanying drawings, in which:

FIG. 1 is a schematic representation of catalytic article design in a layered configuration;

FIG. 2 illustrates bar graphs showing T₅₀ results of CO, NOx and HC during light-off tests on 950/1050° C. lean-rich (10% steam) aged Pd and Rh powder samples with and without SrO for 5 hrs.;

FIG. 3A illustrates bar graphs showing OSC test results at 450° C. on 950/1050° C. lean-rich (10% steam) aged Pd and Rh samples w/wo SrO for 5 hrs.;

FIG. 3B. illustrates bar graphs showing CO, HC and NOx conversion during A-sweep (average λ=1.05, 1.02, 1.01, 1.00, 0.99, 0.98, 0.96) at 350/450° C. on 950/1050° C. lean-rich (10% steam) aged Rh powder samples w/wo Sr) for 5 hrs.;

FIG. 4 illustrates bar graphs showing T₅₀ results of CO, NOx and HC during light-off tests on 950/1050° C. lean-rich (10% steam) aged Pd or Rh/CeO₂−ZrO₂ samples w/wo SrO for 5 hrs.;

FIG. 5 illustrates bar graphs showing OSC test results at 450° C. on 950/1050° C. lean-rich (10% steam) aged Pd or Rh/CeO₂—ZrO₂ samples w/wo SrO for 5 hrs.;

FIG. 6 is STEM/EDS mapping of 3% Pd-5% SrO—Al₂O₃ catalyst aged at 950° C. under lean-rich condition with 10% steam for 5 hrs.;

FIG. 7 is STEM/EDS mapping of 1% Rh-5% SrO—ZrO₂ catalyst aged at 950° C. under lean-rich condition with 10% steam for 5 hrs;

FIG. 8 is a line graph showing FTP-75 mid-bed test results on a vehicle for cumulative CO emission, HC emission and NOx emission of reference catalyst and invention catalyst; and

FIG. 9 is a line graph showing FTP-75 tail-pipe test results on a vehicle for cumulative CO emission, HC emission and NOx emission of reference catalyst and invention catalyst;

FIG. 10 is a perspective view of a honeycomb-type substrate carrier which may comprises the layered catalyst composition in accordance with one embodiment of the presently claimed invention.

FIG. 11 is a partial cross-section view enlarged relative to FIG. 10 and taken along a plane parallel to the end faces of the substrate carrier of FIG. 10, which shows an enlarged view of a plurality of the gas flow passages shown in FIG. 10.

FIG. 12 is a cutaway view of a section enlarged relative to FIG. 10, wherein the honeycomb-type substrate in FIG. 10 represents a wall flow filter substrate monolith.

FIG. 13 illustrates an exhaust system according to one illustrative embodiment of the present invention.

FIG. 14 is a schematic representation of catalytic article designs in a zoned configuration.

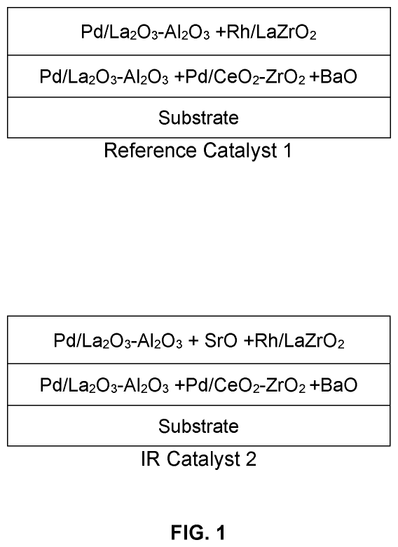

### DETAILED DESCRIPTION OF THE DISCLOSURE

The presently claimed invention now will be described more fully hereafter. The presently claimed invention may be embodied in many different forms and should not be construed as limited to the embodiments set forth herein; rather, these embodiments are provided so that this presently claimed invention will be thorough and complete, and will fully convey the scope of the invention to those skilled in the art. No language in the specification should be construed as indicating any non-claimed element as essential to the practice of the disclosed materials and methods.

The use of the terms “a”, “an”, “the”, and similar referents in the context of describing the materials and methods discussed herein (especially in the context of the following claims) are to be construed to cover both the singular and the plural, unless otherwise indicated herein or clearly contradicted by context.

Recitation of ranges of values herein are merely intended to serve as a shorthand method of referring individually to each separate value falling within the range, unless otherwise indicated herein, and each separate value is incorporated into the specification as if it were individually recited herein.

The term “about” used throughout this specification is used to describe and account for small fluctuations. For example, the term “about” refers to less than or equal to ±5%, such as less than or equal to ±2%, less than or equal to ±1%, less than or equal to ±0.5%, less than or equal to ±0.2%, less than or equal to ±0.1% or less than or equal to ±0.05%. All numeric values herein are modified by the term “about,” whether or not explicitly indicated. A value modified by the term “about” of course includes the specific value. For instance, “about 5.0” must include 5.0.

All methods described herein can be performed in any suitable order unless otherwise indicated herein or otherwise clearly contradicted by context. The use of any and all examples, or exemplary language (e.g., “such as”) provided herein, is intended merely to better illustrate the materials and methods and does not pose a limitation on the scope unless otherwise claimed.

In one aspect, the presently claimed invention provides a PGM containing three-way conversion catalyst composition and a three-way conversion catalytic article incorporating such a composition in a layered configuration for efficient purification of exhaust gases or exhaust stream from internal combustion engines.

In one embodiment, the catalyst composition comprises two or more layers, wherein each layer has pre-determined optimized composition. The order of layers in the catalyst composition have a significant impact on to the catalytic activity of the catalyst composition. In one embodiment, the catalyst composition comprises a first layer and a second layer. In one embodiment, the first layer comprises palladium as a platinum group metal and barium oxide as a promoter supported on support materials. The support material includes at least one alumina component and at least one oxygen storage component. In one embodiment, the first layer is essentially free of strontium, as it is found that the presence of strontium in the first layer (bottom layer) of the catalyst composition negatively affects the performance of the catalyst. In the context of the present invention, the first layer is a bottom layer deposited on a substrate.

In one embodiment, the second layer of the catalyst composition comprises rhodium and optionally, palladium as platinum group metals, and either of strontium oxide and/or barium oxide as a promoter. In one embodiment, palladium present in the second layer is supported on at least one alumina component, whereas rhodium is supported on at least one zirconia component to obtain the enhanced intrinsic catalytic performance. In one embodiment, the second layer comprises rhodium supported on zirconia and rhodium supported on ceria-zirconia. In another embodiment, the second layer comprises rhodium supported on at least one zirconia component.

As used herein, the term “catalyst” or “catalyst composition” refers to a material that promotes a reaction.

As used herein, the term “stream” broadly refers to any combination of flowing gas that may contain solid or liquid particulate matter.

As used herein, the terms “upstream” and “downstream” refer to relative directions according to the flow of an engine exhaust gas stream from an engine towards a tailpipe, with the engine in an upstream location and the tailpipe and any pollution abatement articles such as filters and catalysts being downstream from the engine.

The terms “exhaust stream”, “engine exhaust stream”, “exhaust gas stream”, and the like refer to any combination of flowing engine effluent gas that may also contain solid or liquid particulate matter. The stream comprises gaseous components and is, for example, exhaust of a lean burn engine, which may contain certain non-gaseous components such as liquid droplets, solid particulates and the like. An exhaust stream of a lean burn engine typically further comprises combustion products, products of incomplete combustion, oxides of nitrogen, combustible and/or carbonaceous particulate matter (soot) and un-reacted oxygen and/or nitrogen. Such terms refer as well as to the effluent downstream of one or more other catalyst system components as described herein.

As used herein the term “essentially free of strontium” refers to no external addition of strontium or strontium oxide in the first layer, however it may be optionally present as a fractional amount such as less than 0.01%.

A platinum group metal (PGM) component refers to any component that includes a PGM (Ru, Rh, Os, Ir, Pd, Pt and/or Au). For example, the PGM may be in metallic form, with zero valence, or the PGM may be in an oxide form. Reference to “PGM component” allows for the presence of the PGM in any valence state. The terms “platinum (Pt) component,” “rhodium (Rh) component,” “palladium (Pd) component,” “iridium (Ir) component,” “ruthenium (Ru) component,” and the like refer to the respective platinum group metal compound, complex, or the like which, upon calcination or use of the catalyst, decomposes or otherwise converts to a catalytically active form, usually the metal or the metal oxide.

A “support” in a catalytic material or catalyst composition or catalyst washcoat refers to a material that receives metals (e.g., PGMs), stabilizers, promoters, binders, and the like through precipitation, association, dispersion, impregnation, or other suitable methods. Exemplary supports include refractory metal oxide supports as described herein below.

Refractory metal oxide supports” are metal oxides including, for example, bulk alumina, ceria, zirconia, titania, silica, magnesia, neodymia, and other materials known for such use, as well as physical mixtures or chemical combinations thereof, including atomically-doped combinations and including high surface area or activated compounds such as activated alumina.

Exemplary combinations of metal oxides include alumina-zirconia, alumina-ceria-zirconia, lanthana-alumina, lanthana-zirconia-alumina, baria-alumina, baria-lanthana-alumina, barialanthana-neodymia alumina, and alumina-ceria. Exemplary aluminas include large pore boehmite, gamma-alumina, and delta/theta alumina. Useful commercial aluminas used as starting materials in exemplary processes include activated aluminas, such as high bulk density gamma-alumina, low or medium bulk density large pore gamma-alumina, and low bulk density large pore boehmite and gamma-alumina. Such materials are generally considered as providing durability to the resulting catalyst.

High surface area refractory metal oxide supports” refer specifically to support particles having pores larger than 20 Å and a wide pore distribution. High surface area refractory metal oxide supports, e.g., alumina support materials, also referred to as “gamma alumina” or “activated alumina,” typically exhibit a BET surface area of fresh material in excess of 60 square meters per gram (“m2/g”), often up to about 200 m2/g or higher. Such activated alumina is usually a mixture of the gamma and delta phases of alumina, but may also contain substantial amounts of eta, kappa and theta alumina phases.

As used herein, the term “oxygen storage component” (OSC) refers to an entity that has a multi-valence state and can actively react with reductants such as carbon monoxide (CO) and/or hydrogen under reduction conditions and then react with oxidants such as oxygen or nitrogen oxides under oxidative conditions. Examples of oxygen storage components include rare earth oxides, particularly ceria, lanthana, praseodymia, neodymia, niobia, europia, samaria, ytterbia, yttria, zirconia, and mixtures thereof in addition to ceria. The term “NOx” refers to nitrogen oxide compounds, such as NO or NO2.

The term abatement means a decrease in the amount, caused by any means.

As used herein, “impregnated” or “impregnation” refers to permeation of the catalytic material into the porous structure of the support material.

The catalyst composition in accordance with one embodiment of the presently claimed invention comprises a) a first layer comprising i) palladium supported on at least one alumina component and at least one oxygen storage component; and ii) barium oxide; wherein said first layer is essentially free of strontium, wherein the amount of strontium is less than 0.01%, and b) a second layer comprising i) rhodium supported on at least one zirconia component and/or alumina component; ii) strontium oxide and/or barium oxide; and iii) optionally, palladium supported on at least one alumina component.

In one embodiment, wherein the second layer comprises rhodium supported on at least one zirconia component and/or alumina component; strontium oxide and/ or barium oxide; and palladium supported on at least one alumina component.

In one embodiment, the layered three-way catalyst composition further comprises a substrate, wherein the first layer or the second layer is deposited on the substrate. In one preferred embodiment, the first layer (bottom layer) is deposited on substrate.

The catalyst composition in accordance with one embodiment of the presently claimed invention comprises a) a first layer comprising i) palladium supported on at least one alumina component and at least one oxygen storage component; and ii) barium oxide; wherein said first layer is essentially free of strontium, wherein the amount of strontium is less than 0.01%, b) a second layer comprising i) rhodium supported on at least one zirconia component and/or alumina component; ii) strontium oxide and/ or barium oxide; and iii) optionally, palladium supported on at least one alumina component, and c) a substrate, wherein the first layer is deposited on a substrate and the second layer is deposited on the first layer.

The catalyst composition in accordance with one embodiment of the presently claimed invention comprises a) a first layer comprising i) palladium supported on at least one alumina component and at least one oxygen storage component; and ii) barium oxide; wherein said first layer is essentially free of strontium, wherein the amount of strontium is less than 0.01%, b) a second layer comprising i) rhodium supported on at least one zirconia component and/or alumina component; ii) strontium oxide; and iii) optionally, palladium supported on at least one alumina component, and c) a substrate, wherein the first layer is deposited on a substrate and the second layer is deposited on the first layer.

In one embodiment, the first layer is loaded with 5 to 200 g/ft³ (0.1766 to 7.062 kg/m³) of palladium supported on the alumina component and oxygen storage component.

In another embodiment, the first layer is loaded with 10 to 150 g/ft³ (0.3531 to 5.29 kg/m³) of palladium supported on the alumina component and oxygen storage component.

In another embodiment, the first layer is loaded with 30 to 100 g/ft³ (1.059 to 3.531 kg/m³) of palladium supported on the alumina component and oxygen storage component.

In another embodiment, the second layer is loaded with 0 to 80 g/ft³ (0 to 2.8251 kg/m³) of palladium supported on at least one alumina component.

In another embodiment, the second layer is loaded with 5 to 80 g/ft³ (0.1766 to 2.8251 kg/m³) of palladium supported on at least one alumina component.

In another embodiment, the second layer is loaded with 10 to 50 g/ft³ (0.3531 to 1.765 kg/m³) of palladium supported on at least one alumina component.

In yet another embodiment, the second layer is loaded with 0.2 to 30 g/ft³ (0.007 to 1.059 kg/m³) of rhodium supported on at least one zirconia component.

In yet another embodiment, the second layer is loaded with 2 to 15 g/ft³ (0.070 to 0.5297 kg/m³) of rhodium supported on at least one zirconia component.

Exemplary of the alumina component which is used as a support material includes lanthana-alumina, ceria-alumina, ceria-zirconia-alumina, zirconia-alumina, lanthana-zirconia-alumina, baria-alumina, baria-lanthana-alumina, baria-lanthana-neodymia-alumina, or combinations thereof.

Exemplary of the oxygen storage component includes ceria-zirconia, ceria-zirconia-lanthana, ceria-zirconia-yttrium, ceria-zirconia-lanthana-yttrium, ceria-zirconia-neodymium, ceria-zirconia-praseodymium, ceria-zirconia-lanthana-neodymium, ceria-zirconia-lanthana-praseodymium, ceria-zirconia-lanthana-neodymium-praseodymium, or combinations thereof.

Exemplary of the zirconia component comprises zirconia, lanthana-zirconia, barium-zirconia, and ceria-zirconia. In one embodiment, the zirconia component comprises zirconia. In another embodiment, the zirconia component comprises ceria-zirconia, wherein the amount of ceria is in the range of 0 to 20 wt. % related to the total weight of the zirconia component.

As used herein, the term “promoter” and the term “dopant” may be used interchangeably, both referring to a component that is intentionally added to the support material to enhance an activity of a catalyst as compared to a catalyst that does not have a promoter or dopant intentionally added.

In an embodiment, the exemplary dopant/promoter is barium oxide or strontium oxide.

In one embodiment, the first layer is loaded with 0.01-0.4 g/in³ (0.610-24.40 kg/m³) of barium oxide as a promoter. In one embodiment, the second layer comprises either barium oxide and/or strontium oxide. In one embodiment, the second layer is loaded with 0-0.2 g/in³ (0-12.20 kg/m³) of barium oxide. In one preferred embodiment, the second layer comprises strontium oxide. In some embodiment, the second layer is loaded with 0.01-0.2 g/in³ (0.610-12.20 kg/m³) of strontium oxide.

In one embodiment, the weight ratio of the at least one alumina component to the at least one oxygen storage component in the first layer is in the range of 1:0.2 to 1:1.

In one embodiment, the amount of palladium supported on the alumina component in the first layer is in the range of 20 to 70 wt. % with respect to the total amount of palladium present in the first layer and the amount of palladium supported on the oxygen storage component in the first layer is in the range of 30 to 60% wt. % with respect to the total amount of palladium present in the first layer.

In one exemplary embodiment, the catalyst composition comprises a first layer comprising i) 5 to 200 g/ft³ (0.1766 to 7.062 kg/m³) of palladium supported on at least one alumina component and at least one oxygen storage component; and ii) barium oxide; wherein said first layer is essentially free of strontium, and a second layer comprising 5 to 80 g/ft³ (0.1766 to 2.8251 kg/m³) of palladium supported on at least one alumina component; 0.2 to 30 g/ft³ (0.007 to 1.059 kg/m³) of rhodium supported on at least one zirconia component and/or alumina component; and 0.01 to 0.2 g/in³ (0.610-12.20 kg/m³) of strontium oxide.

In another exemplary embodiment, the catalyst composition comprises a first layer comprising i) 30 to 100 g/ft³ (1.059 to 3.531 kg/m³) of palladium supported on at least one alumina component and at least one oxygen storage component; and ii) barium oxide; wherein said first layer is essentially free of strontium, and a second layer comprising 10 to 50 g/ft³ of palladium supported on at least one alumina component; 0.2 to 30 g/ft³ (0.007 to 1.059 kg/m³) of rhodium supported on at least one zirconia component and/or alumina component; and 0.01 to 0.2 g/in³ of strontium oxide.

In yet another exemplary embodiment, the catalyst composition comprises a first layer comprising i) 10 to 150 g/ft³ (0.3531 to 5.29 kg/m³) of palladium supported on at least one alumina component and at least one oxygen storage component; and ii) barium oxide; wherein said first layer is essentially free of strontium, and a second layer comprising 10 to 50 g/ft³ of palladium supported on at least one alumina component; 2 to 15 g/ft³ (0.070 to 0.5297 kg/m³) of rhodium supported on at least one zirconia component and/or alumina component; and 0.01 to 0.2 g/in³ (0.610-12.20 kg/m³) of strontium oxide.

In one embodiment, the layered three-way catalyst composition further comprises a substrate. Thus, the composition in combination with the substrate can be referred as a catalytic article. i.e. the present catalytic articles comprise a “substrate” having at least two catalytic composition coating disposed thereon. For example, a catalyst article may comprise two washcoats on a substrate.

In one embodiment, a first layer is deposited on the substrate and a second layer is deposited on the first layer. The first layer comprises palladium as a platinum group metal and barium oxide as a promoter supported on support materials, wherein the first layer is essentially free of strontium. The second layer comprises palladium and rhodium as platinum group metals; and strontium oxide and/or barium oxide as a promoter.

As used herein, the term “substrate” refers to the monolithic material onto which the catalyst composition is placed, typically in the form of a washcoat containing a plurality of particles containing a catalytic composition thereon.

Reference to “monolithic substrate” means a unitary structure that is homogeneous and continuous from inlet to outlet.

As used herein, the term “washcoat” has its usual meaning in the art of a thin, adherent coating of a catalytic or other material applied to a substrate material, such as a honeycomb-type carrier member, which is sufficiently porous to permit the passage of the gas stream being treated.

A washcoat is formed by preparing a slurry containing a certain solid content (e.g., 30-90% by weight) of particles in a liquid vehicle, which is then coated onto a substrate and dried to provide a washcoat layer.

As used herein and as described in Heck, Ronald and Farrauto, Robert, Catalytic Air Pollution Control, New York: Wiley-Interscience, 2002, pp. 18-19, a washcoat layer includes a compositionally distinct layer of material disposed on the surface of a monolithic substrate or an underlying washcoat layer. In one embodiment, the substrate contains one or more washcoat layers, and each washcoat layer is different in some way (e.g., may differ in physical properties thereof such as, for example particle size or crystallite phase) and/or may differ in the chemical catalytic functions.

The catalyst article may be “fresh” meaning it is new and has not been exposed to any heat or thermal stress for a prolonged period of time. “Fresh” may also mean that the catalyst was recently prepared and has not been exposed to any exhaust gases. Likewise, an “aged” catalyst article is not new and has been exposed to exhaust gases and elevated temperature (i.e. greater than 500° C.) fora prolonged period of time (i.e., greater than 3 hours).

According to one or more embodiments, the substrate of the catalytic article of the presently claimed invention may be constructed of any material typically used for preparing automotive catalysts and typically comprises a ceramic or a metal monolithic honeycomb structure. The substrate typically provides a plurality of wall surfaces upon which washcoats comprising the catalyst compositions described herein above are applied and adhered, thereby acting as a carrier for the catalyst compositions.

Exemplary metallic substrates include heat resistant metals and metal alloys such as titanium and stainless steel as well as other alloys in which iron is a substantial or major component. Such alloys may contain one or more nickel, chromium, and /or aluminium, and the total amount of these metals may advantageously comprise at least 15 wt. % of the alloy. E.g. 10-25 wt. % of chromium, 3-8% of aluminium, and upto 20 wt. % of nickel. The alloys may also contain small or traces amount of one or more metals such as manganese, copper, vanadium, titanium and the like. The surface of the metal substrate may be oxidized at high temperature, e.g. 1000° C. and higher, to form an oxide layer on the surface of the substrate, improving the corrosion resistance of the alloy and facilitating adhesion of the washcoat layer to the metal surface.

Ceramic materials used to construct the substrate may include any suitable refractory material, e.g., cordierite, silicon carbide, mullite, cordierite-a alumina, silicon nitride, zircon mullite, spodumene, alumina-silica magnesia, zircon silicate, sillimanite, magnesium silicates, zircon, petalite, alumina, aluminosilicates and the like.

Any suitable substrate may be employed, such as a monolithic flow-through substrate having a plurality of fine, parallel gas flow passages extending from an inlet to an outlet face of the substrate such that passages are open to fluid flow. The passages, which are essentially straight paths from the inlet to the outlet, are defined by walls on which the catalytic material is coated as a washcoat so that the gases flowing through the passages contact the catalytic material. The flow passages of the monolithic substrate are thin-walled channels which are of any suitable cross-sectional shape, such as trapezoidal, rectangular, square, sinusoidal, hexagonal, oval, circular, and the like. Such structures contain from about 60 to about 1200 or more gas inlet openings (i.e., “cells”) per square inch of cross section (cpsi), more usually from about 300 to 600 cpsi. The wall thickness of flow-through substrates can vary, with a typical range being between 0.002 and 0.1 inches. A representative commercially-available flow-through substrate is a cordierite substrate having 400 cpsi and a wall thickness of 6 mil, or 600 cpsi and a wall thickness of 4 mil. However, it will be understood that the invention is not limited to a particular substrate type, material, or geometry.

In alternative embodiments, the substrate may be a wall-flow substrate, wherein each passage is blocked at one end of the substrate body with a non-porous plug, with alternate passages blocked at opposite end-faces. This requires that gas flow through the porous walls of the wall-flow substrate to reach the exit. Such monolithic substrates may contain up to about 700 or more cpsi, such as about 100 to 400 cpsi and more typically about 200 to about 300 cpsi. The cross-sectional shape of the cells can vary as described above. Wall-flow substrates typically have a wall thickness between 0.002 and 0.1 inches. A representative commercially available wall-flow substrate is constructed from a porous cordierite, an example of which has 200 cpsi and 10 mil wall thickness or 300 cpsi with 8 mil wall thickness, and wall porosity between 45-65%. Other ceramic materials such as aluminum-titanate, silicon carbide and silicon nitride are also used as wall-flow filter substrates. However, it will be understood that the invention is not limited to a particular substrate type, material, or geometry. Note that where the substrate is a wall-flow substrate, the catalyst composition can permeate into the pore structure of the porous walls (i.e., partially or fully occluding the pore openings) in addition to being disposed on the surface of the walls.

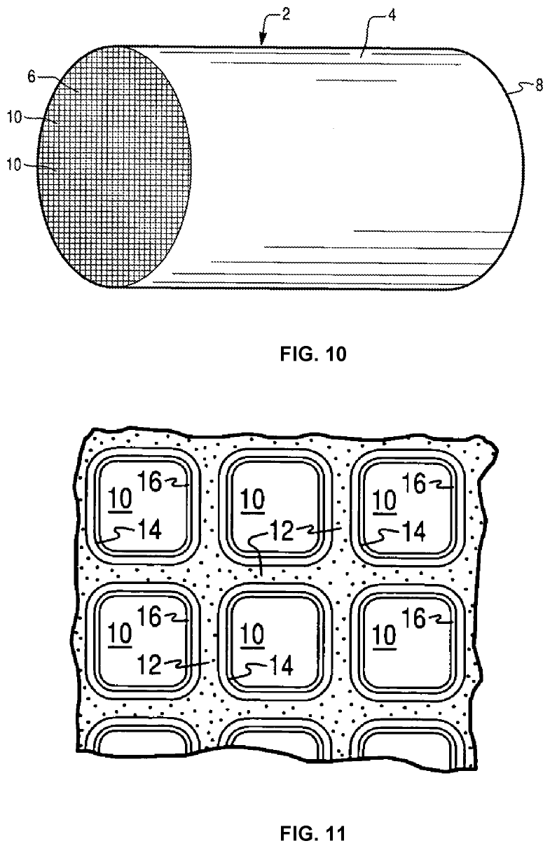

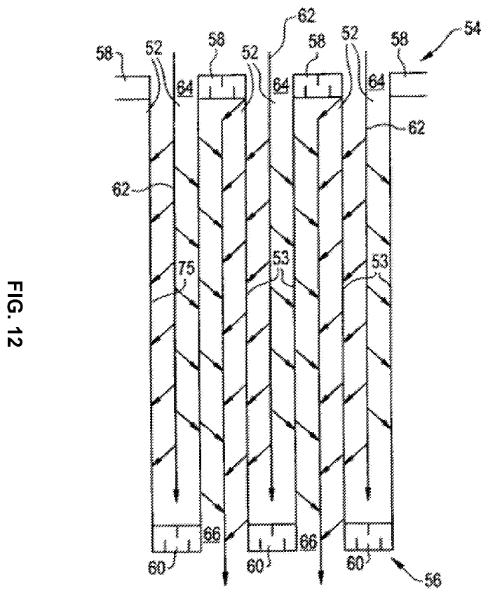

FIGS. 10 and 11 illustrate an exemplary substrate 2 in the form of a flow-through substrate coated with washcoat compositions as described herein. Referring to FIG. 10, the exemplary substrate 2 has a cylindrical shape and a cylindrical outer surface 4, an upstream end face 6 and a corresponding downstream end face 8, which is identical to end face 6. Substrate 2 has a plurality of fine, parallel gas flow passages 10 formed therein. As seen in FIG. 10, flow passages 10 are formed by walls 12 and extend through substrate 2 from upstream end face 6 to downstream end face 8, the passages 10 being unobstructed so as to permit the flow of a fluid, e.g., a gas stream, longitudinally through substrate 2 via gas flow passages 10 thereof. As more easily seen in FIG. 11, walls 12 are so dimensioned and configured that gas flow passages 10 have a substantially regular polygonal shape. As shown, the washcoat compositions can be applied in multiple, distinct layers if desired. In the illustrated embodiment, the washcoats consist of a discrete first washcoat layer 14 adhered to the walls 12 of the substrate member and a second discrete washcoat layer 16 coated over the first washcoat layer 14. In one embodiment, the presently claimed invention is also practiced with two or more (e.g., 3, or 4) washcoat layers and is not limited to the illustrated two-layer embodiment.

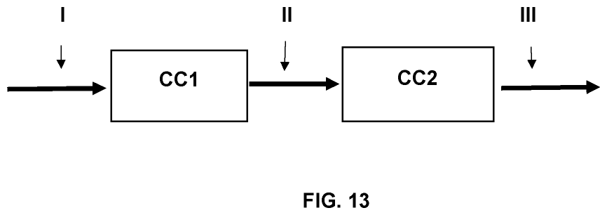

FIG. 12 illustrates an exemplary substrate 2 in the form of a wall flow filter substrate coated with a washcoat composition as described herein. As seen in FIG. 13, the exemplary substrate 2 has a plurality of passages 52. The passages are tubularly enclosed by the internal walls 53 of the filter substrate. The substrate has an inlet end 54 and an outlet end 56. Alternate passages are plugged at the inlet end with inlet plugs 58 and at the outlet end with outlet plugs 60 to form opposing checkerboard patterns at the inlet 54 and outlet 56. A gas stream 62 enters through the unplugged channel inlet 64, is stopped by outlet plug 60 and diffuses through channel walls 53 (which are porous) to the outlet side 66. The gas cannot pass back to the inlet side of walls because of inlet plugs 58. The porous wall flow filter used in this invention is catalyzed in that the wall of said element has thereon or contained therein one or more catalytic materials. Catalytic materials may be present on the inlet side of the element wall alone, the outlet side alone, both the inlet and outlet sides, or the wall itself may consist all, or in part, of the catalytic material. This invention includes the use of one or more layers of catalytic material on the inlet and/or outlet walls of the element.

The presently claimed invention further provides a a layered three-way catalytic article in which the three-way catalyst composition is deposited on a substrate in a layered fashion and its preparation.

In one exemplary embodiment, the catalyst composition or catalytic article comprises a first layer comprising i) 5 to 200 g/ft³ of palladium supported on at least one alumina component and at least one oxygen storage component; and ii) barium oxide; wherein said first layer is essentially free of strontium and is deposited on a ceramic or metallic substrate, and a second layer comprising 5 to 80 g/ft³ of palladium supported on at least one alumina component; 0.2 to 30 g/ft³ of rhodium supported on at least one zirconia component and/or alumina component; and 0.01 to 0.2 g/in³ of strontium oxide, deposited on the first layer.

In another exemplary embodiment, the catalyst composition or catalytic article comprises a first layer comprising i) 30 to 100 g/ft³ of palladium supported on at least one alumina component and at least one oxygen storage component; and ii) barium oxide; wherein said first layer is essentially free of strontium and is deposited on a ceramic or metallic substrate, and a second layer comprising 10 to 50 g/ft³ of palladium supported on at least one alumina component; 0.2 to 30 g/ft³ of rhodium supported on at least one zirconia component and/or alumina component; and 0.01 to 0.2 g/in³ of strontium oxide, deposited on the first layer.

In yet another exemplary embodiment, the catalyst composition or catalytic article comprises a first layer comprising i) 10 to 150 g/ft³ of palladium supported on at least one alumina component and at least one oxygen storage component; and ii) barium oxide; wherein said first layer is essentially free of strontium and is deposited on a ceramic or metallic substrate, and a second layer comprising 10 to 50 g/ft³ of palladium supported on at least one alumina component; 2 to 15 g/ft³ of rhodium supported on at least one zirconia component and/or alumina component; and 0.01 to 0.2 g/in³ of strontium oxide, deposited on the first layer.

In some embodiments, the substrate is coated with at least two layers contained in separate washcoat slurries, wherein at least one layer is in an axially zoned configuration. For example, same substrate is coated with a single washcoat slurry of one layer and a different washcoat slurry of another layer in which either the first layer or the second layer may have zonal configuration.

In one embodiment, the second layer of the catalyst composition comprises zone arrangements. i.e. the second layer comprises a front zone (first zone) and a rear zone (second zone). In one embodiment, the first zone comprises palladium supported on at least one alumina component; rhodium supported on at least one zirconia component and /or alumina component; and strontium oxide and/or barium oxide. In one embodiment, the second zone comprises palladium supported on at least one alumina component; and rhodium supported on at least one zirconia component and/or alumina component.

In another embodiment, the first layer of the catalyst composition comprises a first zone and a second zone. In one embodiment, the first zone comprises at least one alumina component; palladium supported on the alumina; and barium oxide. In one embodiment, the second zone comprises at least one alumina component and at least one oxygen storage component; palladium supported on the alumina component and oxygen storage component; and barium oxide.

In still another embodiment, both the first layer and the second layer comprise a first zone and a second zone. In one embodiment the first zone of the first layer comprises at least one alumina component; palladium supported on the alumina; and barium oxide,

In one embodiment, the second zone of the first layer comprises at least one alumina component and at least one oxygen storage component; palladium supported on the alumina component and oxygen storage component; and barium oxide,

In one embodiment, the first zone of the second layer comprises palladium supported on at least one alumina component; rhodium supported on at least one zirconia component and/or alumina component; and strontium oxide and/or barium oxide. In one embodiment, the second zone of the second layer comprises palladium supported on at least one alumina component; and rhodium supported on at least one zirconia component and /or alumina component.

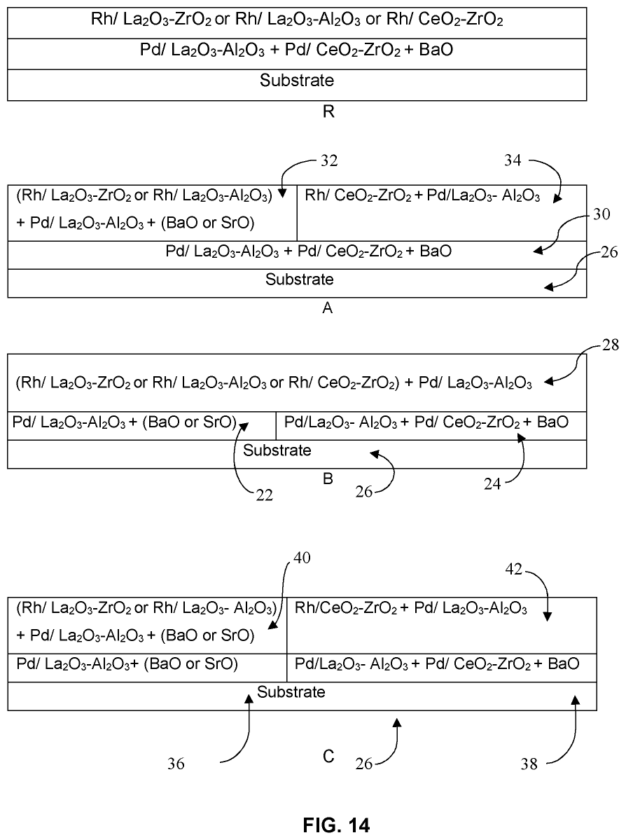

This may be more easily understood by reference to FIG. 14. The reference catalytic article and catalytic articles A, B and C are shown in FIG. 14. Catalyst B shows an embodiment in which the first layer (bottom layer) comprise two washcoat zones (22 and 24) located side by side along the length of the substrate (26) and a second layer comprises one washcoat zone (28) located along entire length of the substrate (26) on the top of washocoat zone (22 and 24).

Catalyst A shows an embodiment in which the first layer (bottom layer) comprises a washcoat zone (30) located along entire length of the substrate (26) and a second layer comprise two washcoat zones (32 and 34) located side by side along the length of the substrate (26) on the top of washocoat zone (30).

Catalyst C shows an embodiment in which the first layer (bottom layer) comprise two washcoat zones (36 and 38) located side by side along the length of the substrate (26) and a second layer comprise two washcoat zones (40 and 42) located side by side along the length of the substrate (26) on the top of washocoat zones (36 and 38).

In some embodiment, the washcoat zone extends from the inlet end of the substrate through the range of about 5 to about 95%, about 10 to about 80%, about 15 to about 75% or about 20 to 60% of the length of the substrate.

In some embodiment, the washcoat zone extends from the outlet end of the substrate through the range of about 5 to about 95%, about 10 to about 80%, about 15 to about 75% or about 20 to 60% of the total axial length of the substrate.

In some exemplary embodiments, washcoated catalytic article designs with zone arrangements are prepared. A Reference Catalyst is prepared in which a bottom layer is formed with palladium supported on La₂O₃—Al₂O₃, palladium supported on CeO₂—ZrO₂ and BaO, whereas a top layer is formed with rhodium supported on La₂O₃—ZrO₂ or CeO₂—ZrO₂ and palladium supported on La₂O₃—Al₂O₃. A catalytic article “A” is prepared which has a bottom layer design similar to the reference catalyst but has a top layer with zoned configuration (i.e. a first zone and a second zone). The first zone includes rhodium supported on La₂O₃—ZrO₂, palladium supported on La₂O₃—Al₂O₃, and BaO or SrO. The second zone includes rhodium supported on CeO₂—ZrO₂ and palladium supported on La₂O₃—Al₂O₃ to prevent the negative effect of BaO or SrO on Rh/CeO₂—ZrO₂. A catalytic article “B” is prepared which has a top layer design similar to the reference catalyst but has bottom layer with zoned configuration (i.e. a first zone and a second zone). The first zone includes palladium supported on La₂O₃—Al₂O₃ and BaO or SrO. The second zone includes palladium supported on La₂O₃—Al₂O₃, palladium supported on CeO₂—ZrO₂, and BaO to prevent the negative effect of BaO or SrO on Pd/CeO₂—ZrO₂. A catalytic article “C” is prepared in which each of top layer and bottom layer has zoned configuration (a first zone and a second zone). The first zone of the bottom layer includes palladium supported on La₂O₃—Al₂O₃, and BaO or SrO. The second zone of the bottom layer includes palladium supported on La₂O₃—Al₂O₃, palladium supported on CeO₂—ZrO₂, and BaO to prevent the negative effect of BaO or SrO on Pd/CeO₂—ZrO₂. The first zone of the top layer includes rhodium supported on La₂O₃—ZrO₂, palladium supported on La₂O₃—Al₂O₃, and BaO or SrO. The second zone of the top layer includes rhodium supported on CeO₂—ZrO₂ and palladium supported on La₂O₃—Al₂O₃] to prevent the negative effect of BaO or SrO on Rh/CeO₂—ZrO₂.

In describing the quantity of washcoat or catalytic metal components or other components of the composition, it is convenient to use units of weight of component per unit volume of catalyst substrate. Therefore, the units, grams per cubic inch (“g/in³”) and grams per cubic foot (“g/ft³”) are used herein to mean the weight of a component per volume of the substrate, including the volume of void spaces of the substrate. Other units of weight per volume such as g/L are also sometimes used.

It is noted that these weights per unit of substrate are typically calculated by weighing the catalyst substrate before and after treatment with the corresponding catalyst washcoat composition, and since the treatment process involves drying and calcining the catalyst substrate at high temperature, these weights represent an essentially solvent-free catalyst coating as essentially all of the evaporable of the washcoat has been removed.

In another aspect of the presently claimed invention there is provided a process for preparing a layered three-way catalyst composition. In one embodiment, the process includes preparing a first layer (catalyst composition 1); preparing a second layer (catalyst composition 2). In one embodiment, the process comprises preparing a first layer; optionally depositing the first layer on a substrate; preparing a second layer; and depositing the second layer on the first layer followed by calcination at a temperature in the range from 500° C. to 600° C., wherein the steps of preparing the first layer and the second layer comprises a technique selected from incipient wetness impregnation technique(A); co-precipitation technique (B) and co-impregnation technique(C),In still another aspect of the presently claimed invention there is provided a process for preparing a layered three-way catalytic article which comprises a substrate coated/deposited with the catalyst composition. The process includes depositing the first layer on a substrate followed by depositing the second layer on the first layer. The process involves calcination which is performed post deposition of the first layer or the second layer or both. Typically, the calcination is carried out at a temperature in the range from 500° C. to 600° C.

The preparation of catalyst composition or catalytic article involves impregnating a support material in particulate form with an active metal solution, such as palladium /and or rhodium precursor solution.

As used herein, “impregnated” or “impregnation” refers to permeation of the catalytic material into the porous structure of the support material.

The techniques used to perform impregnation include incipient wetness impregnation technique(A); co-precipitation technique (B) and co-impregnation technique(C).

Incipient wetness impregnation techniques, also called capillary impregnation or dry impregnation are commonly used for the synthesis of heterogeneous materials, i.e., catalysts. Typically, a metal precursor is dissolved in an aqueous or organic solution and then the metal-containing solution is added to a catalyst support containing the same pore volume as the volume of the solution that was added. Capillary action draws the solution into the pores of the support. Solution added in excess of the support pore volume causes the solution transport to change from a capillary action process to a diffusion process, which is much slower. The catalyst is dried and calcined to remove the volatile components within the solution, depositing the metal on the surface of the catalyst support. The concentration profile of the impregnated material depends on the mass transfer conditions within the pores during impregnation and drying.

The support particles are typically dry enough to absorb substantially all of the solution to form a moist solid. Aqueous solutions of water-soluble compounds or complexes of the active metal are typically utilized, such as rhodium chloride, rhodium nitrate (e.g., Ru (NO)3 and salts thereof), rhodium acetate, or combinations thereof where rhodium is the active metal and palladium nitrate, palladium tetra amine, palladium acetate, or combinations thereof where palladium is the active metal.

Following treatment of the support particles with the active metal solution, the particles are dried, such as by heat treating the particles at elevated temperature (e.g., 100-150° C.) for a period of time (e.g., 1-3 hours), and then calcined to convert the active metal to a more catalytically active form. An exemplary calcination process involves heat treatment in air at a temperature of about 400-550° C. for 10 min to 3 hours. The above process can be repeated as needed to reach the desired level of active metal impregnation.

The above-noted catalyst compositions are typically prepared in the form of catalyst particles as noted above. These catalyst particles are mixed with water to form a slurry for purposes of coating a catalyst substrate, such as a honeycomb-type substrate.

In addition to the catalyst particles, the slurry may optionally contain a binder in the form of alumina, silica, zirconium acetate, colloidal zirconia, or zirconium hydroxide, associative thickeners, and/or surfactants (including anionic, cationic, non-ionic or amphoteric surfactants). Other exemplary binders include bohemite, gamma-alumina, or delta/theta alumina, as well as silica sol. When present, the binder is typically used in an amount of about 1-5 wt. % of the total washcoat loading. Addition of acidic or basic species to the slurry is carried out to adjust the pH accordingly. For example, in some embodiments, the pH of the slurry is adjusted by the addition of ammonium hydroxide, aqueous nitric acid, or acetic acid. A typical pH range for the slurry is about 3 to 12.

The slurry can be milled to reduce the particle size and enhance particle mixing. The milling is accomplished in a ball mill, continuous mill, or other similar equipment, and the solids content of the slurry may be, e.g., about 20-60 wt. %, more particularly about 20-40 wt. %. In one embodiment, the post-milling slurry is characterized by a D90 particle size of about 10 to about 40 microns, preferably 10 to about 30 microns, more preferably about 10 to about 15 microns. The D₉₀ is determined using a dedicated particle size analyzer. The equipment employed in this example uses laser diffraction to measure particle sizes in small volume slurry. The D₉₀, typically with units of microns, means 90% of the particles by number have a diameter less than that value.

The slurry is coated on the catalyst substrate using any washcoat technique known in the art. In one embodiment, the catalyst substrate is dipped one or more times in the slurry or otherwise coated with the slurry. Thereafter, the coated substrate is dried at an elevated temperature (e.g., 100-150° C.) fora period of time (e.g., 10 min-3 hours) and then calcined by heating, e.g., at 400-700° C., typically for about 10 minutes to about 3 hours. Following drying and calcining, the final washcoat coating layer is viewed as essentially solvent-free.

After calcining, the catalyst loading obtained by the above described washcoat technique can be determined through calculation of the difference in coated and uncoated weights of the substrate. As will be apparent to those of skill in the art, the catalyst loading can be modified by altering the slurry rheology. In addition, the coating/drying/calcining process to generate a washcoat can be repeated as needed to build the coating to the desired loading level or thickness, meaning more than one washcoat may be applied.

In certain embodiments, the coated substrate is aged, by subjecting the coated substrate to heat treatment. In one particular embodiment, aging is done at a temperature of from about 20 850° C. to about 1050° C. in an environment of 10 vol. % water in air for 20 hours. Aged catalyst articles are thus provided in certain embodiments. In certain embodiments, particularly effective materials comprise metal oxide-based supports (including, but not limited to substantially 100% ceria supports) that maintain a high percentage (e.g., about 95-100%) of their pore volumes upon aging (e.g., at about 850° C. to about 1050° C., 10 vol. % water in air, 20 hours aging).

In one illustrative embodiment, the incipient wetness impregnation technique (A) comprises the following steps:

Preparation of the first layer:
loading barium oxide on at least one alumina component and at least one oxygen storage component to obtain a first mixture, subjecting the mixture to calcination to obtain a first calcined mixture, and impregnating the first calcined material with palladium to obtain a first layer.

Preparation of the second layer:
loading strontium oxide or barium oxide on at least one alumina component to obtain a second mixture, subjecting the second mixture to calcination to obtain a second calcined mixture, impregnating the second calcined mixture with palladium to obtain a first material, loading strontium oxide or barium oxide on at least one zirconia component to obtain a third mixture, subjecting the third mixture to calcination to obtain a third calcined mixture, impregnating the third calcined material with rhodium to obtain a second material, mixing the first material and the second material to obtain a second layer.

Preparation of the catalyst composition:
depositing the second layer on the first layer to obtain the layered three-way catalyst composition.

In one illustrative embodiment, the co-precipitation technique (B) comprises the following steps:

Preparation of the first layer:
incorporating barium oxide and palladium into at least one alumina component and at least one oxygen storage component by co-precipitation with at least one precursor of the alumina component and at least one precursor of the oxygen storage component to obtain a first mixture, subjecting the first mixture to calcination to obtain a first layer;

Preparation of the second layer:
incorporating either of strontium oxide or barium oxide and palladium into at least one alumina component by co-precipitation with at least one precursor of the alumina component to obtain a second mixture, subjecting the second mixture to calcination to obtain a first material, incorporating either of strontium oxide or barium oxide and rhodium into at least one zirconia component by co-precipitation to obtain a third mixture, subjecting the third mixture to calcination to obtain a second material, mixing the first material and the second material to obtain the second layer, and

Preparation of the catalyst composition:
depositing the second layer on the first layer to obtain the layered three-way catalyst composition.

In one illustrative embodiment, co-impregnation technique (B) comprise the following steps:

Preparation of the first layer:
incorporating barium oxide or its precursor and palladium or its precursor into at least one alumina component and at least one oxygen storage component by co-impregnation to obtain a first mixture, subjecting the first mixture to calcination to obtain a first layer.

Preparation of the second layer:
incorporating either of strontium oxide or its precursor or barium oxide or its precursor and palladium or its precursor into at least one alumina component by co-impregnation to obtain a second mixture, subjecting the second mixture to calcination to obtain a first material, incorporating either of strontium oxide or its precursor or barium oxide or its precursor and rhodium or its precursor into at least one zirconia component by co-impregnation to obtain a third mixture, subjecting the third mixture to calcination to obtain a second material, mixing the first material and the second material to obtain the second layer.

Preparation of the catalyst composition:
depositing the second layer on the first layer to obtain the layered three-way catalyst composition.

In one embodiment, the calcination is carried out at a temperature in the range from 500° C. to 600° C.

In one embodiment, the precursor of barium is selected from barium nitrate, barium chloride, barium acetate, barium oxalate, barium aluminate, barium borate, barium fluoride, barium carbonate, barium hydroxide, barium sulfate, and barium sulphite.

In one embodiment, the precursor of strontium is selected from strontium nitrate, strontium sulfate, strontium acetate, strontium chloride, and strontium oxalate.

In one embodiment, the precursor of palladium is selected from palladium chloride, palladium nitrate, and palladium acetate. In one embodiment, the precursor of rhodium is selected from rhodium chloride, rhodium nitrate, tetraamine palladium nitrate, and rhodium acetate.

Another aspect of the presently claimed invention directed to a method of treating a gaseous exhaust stream comprising hydrocarbons, carbon monoxide, and nitrogen oxide. The method comprising contacting said exhaust stream with the presently claimed catalyst composition or the catalyst composition obtained by the process described hereinabove.

In still another aspect, the presently claimed invention provides a method of reducing hydrocarbons, carbon monoxide, and nitrogen oxide levels in an exhaust gas. The method comprises contacting the exhaust gas with the presently claimed catalyst composition or the catalyst composition obtained by the process described herein above to reduce the levels of hydrocarbons, carbon monoxide, and nitrogen oxide in the exhaust gas.

In one embodiment, the hydrocarbons, carbon monoxide, and nitrogen oxide levels present in the exhaust gas are reduced by at least 50% compared to the hydrocarbons, carbon monoxide, and nitrogen oxide levels in the exhaust gas stream prior to contact with the catalyst composition.

In some embodiment, the catalytic article converts hydrocarbons to carbon dioxide and water. In some embodiments, the catalytic article converts at least about 60%, or at least about 70%, or at least about 75%, or at least about 80%, or at least about 90%, or at least about 95% of the amount of hydrocarbons present in the exhaust gas stream prior to contact with the catalytic article.

In some embodiment, the catalytic article converts carbon monoxide to carbon dioxide. In some embodiments, the catalytic article converts at least about 60%, or at least about 70%, or at least about 75%, or at least about 80%, or at least about 90%, or at least about 95% of the amount of carbon monoxide present in the exhaust gas stream prior to contact with the catalytic article. In some embodiment, the catalytic article converts nitrogen oxides to nitrogen.

In some embodiments, the catalytic article converts at least about 60%, or at least about 70%, or at least about 75%, or at least about 80%, or at least about 90%, or at least about 95% of the amount of nitrogen oxides present in the exhaust gas stream prior to contact with the catalytic article. In some embodiment, the catalytic article converts at least about 50%, or at least about 60%, or at least about 70%, or at least about 80%, or at least about 90%, or at least about 95% of the total amount of hydrocarbons, carbon dioxide, and nitrogen oxides combined present in the exhaust gas stream prior to contact with the catalytic article.

In yet another aspect, the presently claimed invention provides use of the catalyst composition of presently claimed invention or the catalyst composition obtained by the process described herein above for purifying gaseous exhaust stream comprising hydrocarbons, carbon monoxide, and nitrogen oxide.

In yet another aspect, the presently claimed invention provides an exhaust system for internal combustion engines comprising the three-way catalyst composition according to presently claimed invention or the catalyst composition obtained by the process described herein above positioned downstream from an internal combustion engine in fluid communication with the exhaust gas stream.

The engine can be a gasoline engine and/or compressed natural gas (CNG) engine (e.g., for gasoline and compressed natural gas mobile sources such as gasoline or CNG cars and motorcycles) or can be an engine associated with a stationary source (e.g., electricity generators or pumping stations).

### EXAMPLES

Aspects of the presently claimed invention are more fully illustrated by the following examples, which are set forth to illustrate certain aspects of the present invention and are not to be construed as limiting thereof.

### Example 1

### Preparation of Powder Catalysts and Testing Thereof

A. Reference Catalyst A: 3% Pd on alumina
10.7 grams of palladium nitrate solution (Pd=29.7%) was weighed and diluted in water. The obtained palladium nitrate solution was impregnate onto alumina to obtain a mixture which was dried at 150° C. for 2 hours and calcined at 550° C. for 2 hours.

B. Invention Catalyst B: 3% Pd-5% SrO on alumina:
Palladium nitrate and SrO from acetate or nitrate were dissolved in water. The obtained solution of palladium and strontium was impregnated onto alumina to obtain a mixture which was dried at 150° C. for 2 hours and calcined at 550° C. for 2 hours.

C. Reference Catalyst C: 0.5% Rh on high surface area Zirconia (ZrO₂)
4.6 grams of rhodium nitrate solution (Rh=10.9%) was weighed and diluted in water for 100% incipient wetness. Rhodium nitrate solution was then impregnated onto the zirconia to obtain a mixture which was dried at 150° C. for 2 hours and calcined at 550° C. for 2 hours.

D. Invention Catalyst D: 0.5Rh-5% SrO on high surface area Zirconia (ZrO₂)
4.6 grams of rhodium nitrate solution (Rh=10.9%) and strontium nitrate or acetate were weighed and diluted in water for 00% incipient wetness. The obtained solution was then impregnated onto the zirconia to obtain a mixture which was dried at 150° C. for 2 hours and calcined at 550° C. for 2 hours.

E. Reference Catalyst E: 3%Pd on Ce—O₂—ZrO₂
10.7 grams of palladium nitrate solution (Pd=29.7%) was weighed and diluted in water for incipient wetness. Palladium nitrate was impregnated onto the CeO₂—ZrO₂ to obtain a mixture which was dried at 150° C. for 2 hours and calcined at 550° C. for 2 hours.

F. Invention Catalyst F: 3% Pd-5% SrO on CeO₂—ZrO₂ 40% CeO₂):
Palladium nitrate and SrO from acetate or nitrate were dissolved in water. The obtained solution of palladium and strontium was impregnated onto CeO₂—ZrO₂ to obtain a mixture which was dried at 150° C. for 2 hours and calcined at 550° C. for 2 hours.

Aging:

The catalyst composition was aged at 950/1050° C. under Lean-Rich condition with 10% steam for 5 hrs. in a high throughput experimental reactor to measure light-off performance, lambda sweep conversion of CO, HC and NOx, and the oxygen storage capacity (OSC).

Testing of Powder Catalyst

Light Off Performance Using SrO as a Promoter

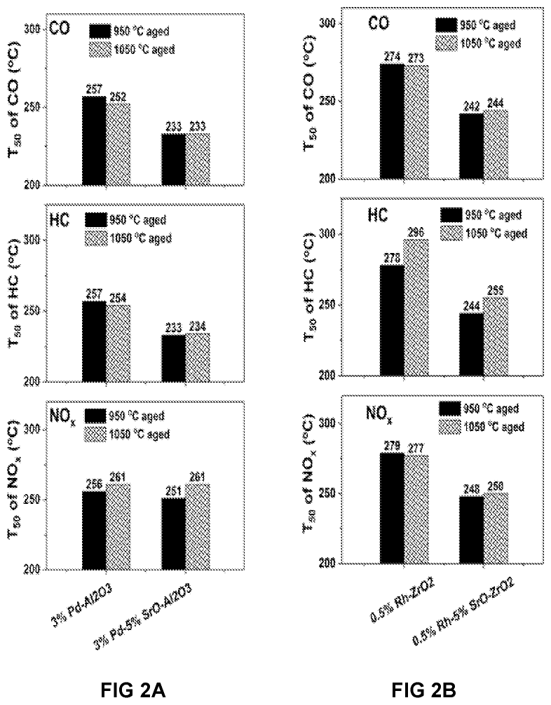

Light off performance of the powder catalyst containing Pd—Al₂O₃ and SrO and powder catalyst containing Rh—ZrO₂ with SrO was screened and compared with respective reference catalysts which are devoid of SrO. As shown in FIG. 2A, it can be seen that compared to Pd—Al₂O₃ reference catalyst, the inventive Pd—SrO—Al₂O₃ catalyst composition showed improved light off performance after 950 and 1050° C. aging conditions for CO and HC. As shown in FIG. 2B, it can be seen that compared to Rh—ZrO₂ reference catalyst, the inventive Rh—SrO—ZrO₂ catalyst showed significantly improved light off performance after 950 and 1050° C. aging conditions for CO, HC and NOx.

OSC Performance Using SrO as a Promoter

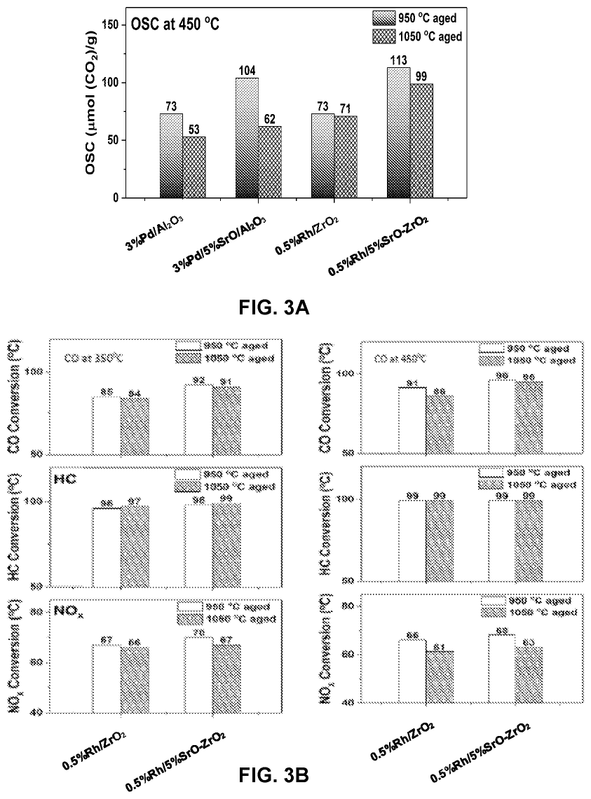

The catalysts were tested for oxygen storage capacity (OSC). FIG. 3A demonstrates OSC test results at 450° C. on 950/1050° C. lean-rich aged Pd and Rh samples with/without SrO. Compared to reference catalyst, the inventive catalyst Pd—SrO—Al₂O₃ showed improved OSC at 450° C. The OSC function for Pd containing samples was originated from the redox cycle of PdOx H Pd. It is observed that SrO obviously enhanced this PdOx H Pd redox process. The inventive catalyst Rh—SrO—ZrO₂, also showed significantly improved OSC function due to presence of SrO compared to reference catalyst. The OSC function of Rh containing samples is mainly from the redox cycle of RhOx↔Rh. The introduction of SrO into Rh—ZrO₂ significantly enhanced the redox cycle of RhOx↔Rh, which is the reason for its improved TWC performance.

CO, HC and NOx Conversion During A-Sweep Using SrO as a Promoter

The catalysts were tested for CO, HC and NOx conversion during A-sweep at 350/450° C. FIG. 3B demonstrates that compared to Rh—ZrO₂ reference, the invented catalyst Rh—SrO—ZrO₂ promoted the conversion of CO, HC and NOx at both temperatures under both aging conditions (950 & 1050° C.). These results clearly indicate that SrO promoter has positive effect for Rh/ZrO₂ catalyst for TVVC application.

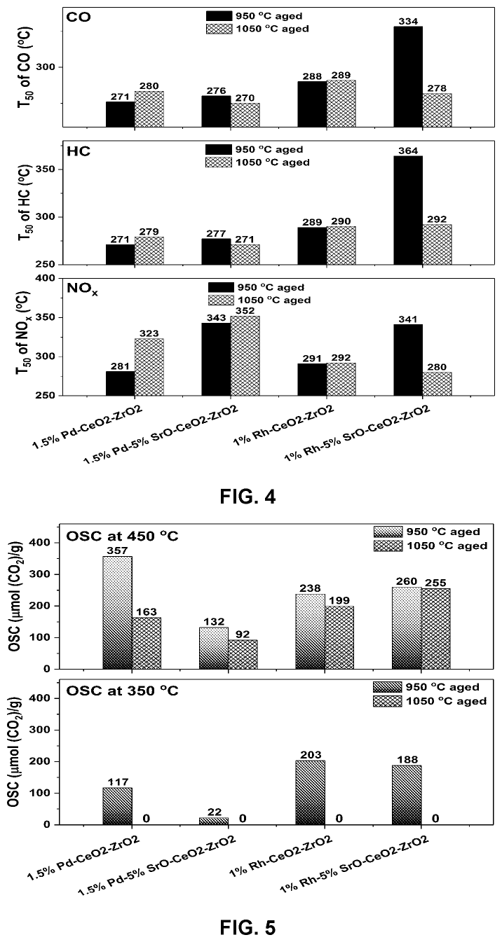

Pd—CeO₂—ZrO₂ (with higher CeO2 content as 40%) and Rh—CeO₂—ZrO₂ (with lower CeO₂ content as 10%) catalysts with and without SrO promoter were tested. FIG. 4 demonstrates that, compared to Pd—CeO₂—ZrO₂ reference catalyst, the catalyst Pd—SrO—CeO₂—ZrO₂ did not change the T₅₀ of CO and HC much, but significantly increased the T50 of NOx under both aging conditions, indicating that the OSC function of Pd—CeO₂—ZrO₂ catalyst might be negatively affected which could lead to the decrease of lambda sweep conversion.

It is also found that compared to Rh—CeO₂—ZrO₂ reference catalyst, the invented catalyst Rh—SrO—CeO₂—ZrO₂ showed negative effect after 950° C. aging, and this negative effect vanishes after 1050° C. aging.

FIG. 5 demonstrates OSC test results at 350/450° C. on 950/1050° C. lean-rich aged Pd and Rh samples supported on CeO₂—ZrO₂ with and without SrO.

It is found that the catalyst Pd—SrO—CeO₂—ZrO₂ after 950/1050° C. aging shows detrimental OSC function at both 350 and 450° C. This sharp decrease in OSC function induced by SrO well explained the TVVC performance deterioration in light-off and pollutant conversion, suggesting that SrO cannot be placed together with Pd/OSC component with high CeO₂ content in fully formulated TVVC catalysts.

It is further found that the catalyst Rh—SrO—CeO₂—ZrO₂ aged at 950° C. decreased the OSC function at 350° C., while SrO significantly enhanced the OSC function at 450° C. especially for 1050° C. aged sample. Thus, for TWC application with high temperature aging condition (>1050° C.), SrO can be a potential candidate as promoter for Rh/OSC catalyst with low CeO₂ content.

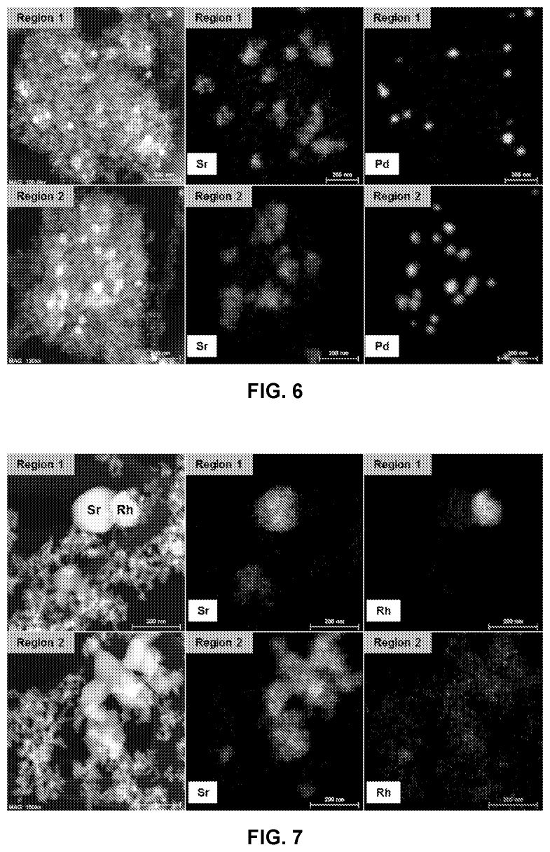

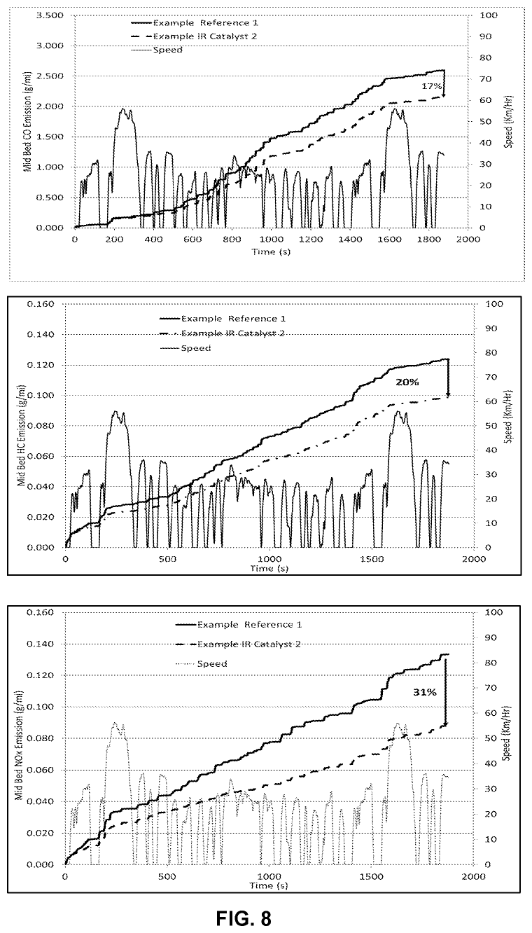

To verify if there is strong interaction between SrO promoter and PGM species, Scanning Transmission Electron Microscopy/Energy Dispersive X-ray Spectroscopy (STEM/EDS) was performed and the results are shown in FIGS. 6 and 7.

FIG. 6 illustrates STEM/EDS mapping results of two representative regions of 3% Pd-5% SrO—Al₂O₃ catalyst after 950° C. aging. It is very clear that after lean-rich aging at 950° C., the Pd species on Al₂O₃ sintered to a certain extent forming 40-50 nm particles. The SrO species were randomly dispersed on Al₂O₃, and more than 50% visible Pd particles were located (sitting) on top of SrO aggregates. The Electron Energy Loss Spectroscopy (EELS) was also collected for Pd particles on Al₂O₃ and Pd particles associated with SrO, which clearly showed that the Pd particles on Al₂O₃ were more in oxidized state (PdO) and Pd particles associated with SrO were more in metallic state (Pd⁰). This means that SrO has strong electron donation effect to PdOx thus resulting in more reduced Pd⁰ species and greatly promoting its TWC performance. In-situ FTIR also confirmed that 3% Pd-5% SrO—Al₂O₃ catalyst was much easier to be reduced upon CO adsorption even at room temperature than 3% Pd—Al₂O₃ reference.

FIG. 7 demonstrates STEM/EDS mapping results of two representative regions of 1% Rh-5% SrO—ZrO₂ catalyst after 950° C. aging. Two types of Rh species on ZrO₂ with SrO promoter after aging, were found. One is severely aggregated Rh particles (Region 1, ca. 100 nm) and second is finely dispersed Rh species (Region 2, below 10 nm). EDS mapping results shows that both the aggregated Rh particles and the finely dispersed Rh species are in close contact with SrO. Also, in-situ FTIR confirmed that 1% Rh-5% SrO—ZrO₂ catalyst was much easier to be reduced than 1% Rh—ZrO₂ reference upon CO adsorption at low temperature, which re-confirmed that SrO has electronic donation effect to RhOx, thus improving its reducibility and enhancing the TVVC performance.

### Example 2

### Preparation of a Layered Three-Way Catalyst (Reference Catalyst, Reference 1):

A. Bottom Layer (First Layer) Preparation:

Palladium nitrate solution (53.2 g with Pd concentration=27.6%) was impregnated onto alumina stabilized with 4% La oxide (La doped alumina=1381 grams) by using incipient wetness method. The mixture was then calcined at 550° C. for 2 hours.

Separately, palladium nitrate (53.2 grams) was impregnated onto Oxygen storage material (OSM) (2302 grams: OSM: Ce=40%, Zr=60%, La 5%, Y=5% as oxides) by using incipient wetness method. The mixture was then calcined at 550° C. for 2 hours.

Slurry Preparation:

Calcined palladium on alumina was added to water under mixing. To this, barium acetate (150.7 g) and barium sulphate (276.9 g) were added to obtain a mixture. pH of the mixture was adjusted to 4.5-5 using nitric acid. The mixture was continuously milled using an Eiger mill to particle size distribution at 90% less than 20 micro meters. To this, calcined Pd on OSM was added and pH was adjusted to 4.5 to 5 using nitric acid and milled to particle size distribution (PSD) at 90% less than 14-16 micrometers.

Finally, alumina binder dispersal (455 g at 20% solid) was added to the mixture and mixed well. The obtained final mixture was coated to about 2.2 g/in³ followed by drying and calcination at 550° C. for 2 hours.

B. Top Layer (Second Layer) Preparation:

29.94 grams of palladium nitrate (Pd concentration=27.1) was impregnated on lanthanum doped alumina by incipient wetness. The mixture was calcined at 550° C. for 2 hours. To this mixture, water was added to make a slurry. pH of the slurry was adjusted to 4.5-5. The slurry was continuously milled to PSD of 90% less than 12-14 micrometers.

Separately, 18.75 g rhodium nitrate was impregnated onto 10% La oxide doped Zirconia (Rh concentration=9.4%) by incipient wetness. The Rh on La zirconia was added to water and pH was maintained at 8-8.5 using methanol amine. Later, pH was further adjusted to 4.5-5 using nitric acid. The obtained mixture was then milled to PSD at 90% less than 12-14 micrometers.

In the next step, both the slurries were mixed together. To this mixture, alumina binder (20% alumina solid) was added and the obtained final slurry was coated onto the first layer with a wash coat loading 1.3 g/in³.

Overall Wash Coat Loading:
1. Bottom layer coat: Pd=27.6 g/ft³ (divided equally between alumina and OSM). OSM=1.25 g/in³, Alumina=0.75 g/in³, BaO=0.15 g/in³, alumina binder: 0.05 g/in³. Total bottom wash coat loading=2.216 g/in³.
2. Top layer coat: Pd=18.4 g/ft³, Rh=4 g/ft³. Alumina=0.5 g/in³, La—ZrO₂=0.75 g/in³, alumina binder: 0.05 g/in³. Total top wash coat loading: 1.3 g/in³.

### Example 3

### Preparation of a Layered Three-Way Catalyst (Invention Catalyst, IR Catalyst 2)

A. Bottom Layer (First Layer) Preparation:

The bottom layer was prepared similar to bottom layer of the reference catalyst.

B. Top Layer (Second Layer) Preparation:

29.4 grams of palladium nitrate (Pd concentration=27.1) was impregnated on 381 g of lanthanum doped alumina by incipient wetness. The mixture was calcined at 550° C. for 2 hours. To this mixture, water was added to make a slurry. pH of the slurry was adjusted to 4.5-5. Add 33 g of strontium sulphate (SrO=56.1%). The slurry was continuously milled to PSD of 90% less than 12-14 micrometers.

Separately, 18.23 g rhodium nitrate was impregnated onto 567 g of 10% La oxide doped Zirconia (Rh concentration=9.4%) by incipient wetness. The impregnated rhodium on 10% La₂O₃ on zirconia was added to water and pH was maintained at 8-8.5 using methanol amine. Later, pH was further adjusted to 4.5-5 using nitric acid. The obtained mixture was then milled to PSD at 90% less than 12-14 micrometers.

In the next step, both the slurries were mixed together. To this mixture, alumina binder (20% alumina solid) was added and the obtained final slurry was coated onto the first layer with a wash coat loading 1.3 g/in³.

Overall Wash Coat Loading:
1. Bottom layer coat: Pd=27.6 g/ft³ (divided equally between alumina and OSM). OSM=1.25 g/in³, Alumina=0.75 g/in³, BaO=0.15 g/in³, alumina binder: 0.05 g/in³. Total wash coat loading=2.216
2. Top layer coat: Pd=18.4 g/ft³, Rh=4 g/ft³. Alumina=0.5 g/in³, La—ZrO₂=0.75 g/in³, SrO=0.025 g/in³, alumina binder: 0.05 g/in³ with total top wash coat loading of 1.3 g/m³.

Testing of Catalysts on a Vehicle

The washcoated catalytic articles (Example 3—Invention Catalyst and Example 2—Reference Catalyst 4.16″×3.0″, 400/4) were fuel cut aged on an engine at 950° C. for 75 hours, and then tested as close couple (CC-1) catalysts on a vehicle for FTP-75 cycles with Pd:Rh loading of 46/4 g/ft³. The close couple (CC-2 catalyst) was kept the same for all testing, which was a simple Pd bottom coat and Rh top coat catalyst with Pd:Rh loading of 14/4 g/ft³. The exhaust system with an arrangement of engine out (I), mid bed (II) and tail pipe emission (III) is illustrated in FIG. 13.

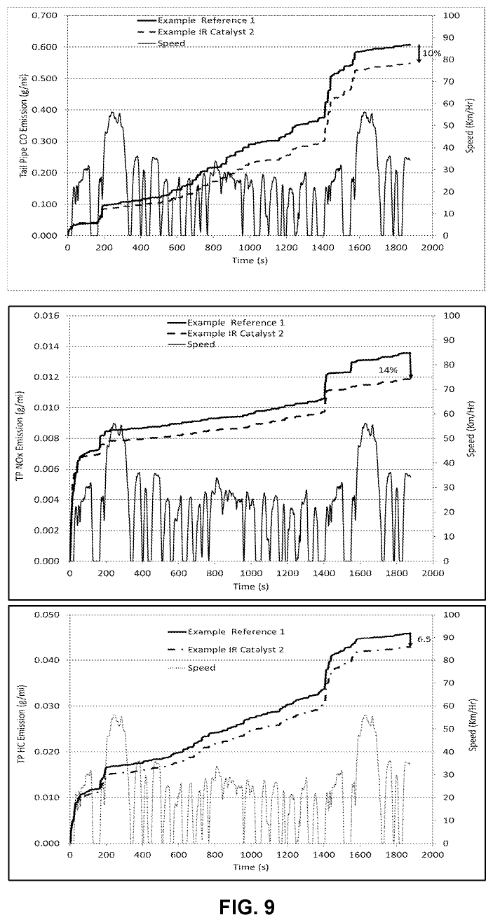

FIG. 8 demonstrates the mid-bed CO, HC and NOx cumulative emission on engine for Reference Catalyst 1 (Reference 1) and Invention Catalyst (IR Catalyst 2). Comparing to Reference Catalyst 1, it is clearly observed that the Invention Catalyst shows well improved HC, NOx and CO performance with the cumulative HC, NOx and CO emission decreased by 20%, 31% and 17%, respectively. These results clearly indicate that using SrO as an electronic promoter for PGM could be well transferred to the fully formulated TWC catalysts with improved catalytic performance.

FIG. 9 demonstrates the tail-pipe CO, HC and NOx cumulative emission on engine for Reference Catalyst 1 (Reference 1) and Invention Catalyst (IR Catalyst 2). Comparing to Reference Catalyst 1, it is clearly observed that Invention Catalyst (with SrO in the top layer as a promoter) showed well improved HC, NOx and HC performance with the cumulative CO, NOx and HC emission decreased by 10%, 6.5% and 20%, respectively. These results also clearly indicate that using SrO as an electronic promoter for PGM could be well transferred to the washcoated TWC catalysts with improved catalytic performance.

Reference throughout this specification to “one embodiment,” “certain embodiments,” “one or more embodiments” or “an embodiment” means that a particular feature, structure, material, or characteristic described in connection with the embodiment is included in at least one embodiment of the presently claimed invention. Thus, the appearances of the phrases such as “in one or more embodiments,” “in certain embodiments,” “in some embodiments,” “in one embodiment,” or “in an embodiment” in various places throughout this specification are not necessarily referring to the same embodiment of the presently claimed invention. Furthermore, the particular features, structures, materials, or characteristics may be combined in any suitable manner in one or more embodiments. All of the various embodiments, aspects, and options disclosed herein can be combined in all variations, regardless of whether such features or elements are expressly combined in a specific embodiment description herein. This presently claimed invention is intended to be read holistically such that any separable features or elements of the disclosed invention, in any of its various aspects and embodiments, should be viewed as intended to be combinable unless the context clearly dictates otherwise.

Although the embodiments disclosed herein have been described with reference to particular embodiments it is to be understood that these embodiments are merely illustrative of the principles and applications of the presently claimed invention. It will be apparent to those skilled in the art that various modifications and variations can be made to the methods and apparatus of the presently claimed invention without departing from the spirit and scope of the presently claimed invention. Thus, it is intended that the presently claimed invention include modifications and variations that are within the scope of the appended claims and their equivalents, and the above-described embodiments are presented for purposes of illustration and not of limitation.

1. A layered three-way catalyst composition for purification of exhaust gases from internal combustion engines comprising:
a) a first layer comprising:
i) palladium supported on one or more alumina component and one or more oxygen storage component; and
ii) barium oxide;
wherein the amount of strontium in the first layer is less than 0.01%; and
b) a second layer comprising:
i) rhodium supported on one or more of a zirconia component and an alumina component;
ii) one or more of strontium oxide and barium oxide; and
iii) optionally, palladium supported on one or more alumina component.

2. The layered three-way catalyst composition according to claim 1, wherein the composition further comprises a substrate, and wherein the first layer or the second layer is deposited on the substrate.

3. The layered three-way catalyst composition according to claim 1, wherein the alumina component is chosen from lanthana-alumina, ceria-alumina, ceria-zirconia-alumina, zirconia-alumina, lanthana-zirconia-alumina, baria-alumina, baria-lanthana-alumina, baria-lanthana-neodymia-alumina, or combinations thereof; wherein the oxygen storage component is chosen from ceria-zirconia, ceria-zirconia-lanthana, ceria-zirconia-yttrium, ceria-zirconia-lanthana-yttrium, ceria-zirconia-neodymium, ceria-zirconia-praseodymium, ceria-zirconia-lanthana-neodymium, ceria-zirconia-lanthana-praseodymium, ceria-zirconia-lanthana-neodymium-praseodymium, or combinations thereof; and wherein the zirconia component is chosen from zirconia, lanthana-zirconia, barium-zirconia, and ceria-zirconia.

4. The layered three-way catalyst composition according to claim 1, wherein the zirconia component comprises ceria-zirconia, and the amount of ceria ranges from 0 wt. % to 20 wt. % based on the total weight of the zirconia component.

5. The layered three-way catalyst composition according to claim 1, wherein the weight ratio of the one or more alumina component to the one or more oxygen storage component in the first layer ranges from 1:0.2 to 1:1.

6. The layered three-way catalyst composition according to claim 1, wherein the first layer comprises from 5 g/ft³ to 200 g/ft³ (0.1766 kg/m³to 7.062 kg/m³) of palladium supported on the one or more alumina component and the one or more oxygen storage component; wherein the second layer comprises from 0 g/ft³ to 80 g/ft³ (0 kg/m³-2.8251 kg/m³) of palladium supported on one or more alumina component; wherein the second layer comprises from 0.2 g/ft³ to 30 g/ft³ (0.007 kg/m³-1.059 kg/m³) of rhodium supported on the one or more zirconia component; wherein the first layer is comprises from 0.01 g/in³-0.4 g/in³ (0.610 kg/m³-24.40 kg/m³) of barium oxide; and wherein the second layer is loaded withcomprises from 0 g/in³-0.2-g/in³ (0 kg/m³-12.20 kg/m³) of barium oxide or from 0.01 g/in³-0.2 g/in³ (0.610 kg/m³-12.20 kg/m³) of strontium oxide.

7. The layered three-way catalyst composition according to claim 1, wherein the amount of palladium supported on the alumina component in the first layer ranges from 20 wt. % to 70 wt. % based on the total amount of palladium present in the first layer, and the amount of palladium supported on the oxygen storage component in the first layer ranges from 30 wt. % to 60 wt. % based on the total amount of palladium present in the first layer.

8. The layered three-way catalyst composition according to claim 1, wherein the second layer comprises rhodium supported on zirconia and rhodium supported on ceria-zirconia.

9. The layered three-way catalyst composition according to claim 1, wherein the second layer comprises rhodium supported on the one or more zirconia component and the alumina component;
strontium oxide and barium oxide; and palladium supported on the one or more alumina component.

10. The three-way catalyst composition according to claim 2, wherein the substrate is a ceramic or a metallic.

11. The layered three-way catalyst composition according to claim 1, wherein, the second layer further comprises a first zone and a second zone,
wherein the first zone comprises:
palladium supported on the one or more alumina component;
(ii) rhodium supported on the one or more of the zirconia component and the alumina component; and
(iii) strontium oxide and/or barium oxide,
wherein the second zone comprises:
(i) palladium supported on the one or more alumina component; and
(ii) rhodium supported on the one or more of the zirconia component and the alumina component.

12. The layered three-way catalyst composition according to claim 1, wherein, the first layer further comprises a first zone and a second zone,
wherein the first zone comprises:
i) one or more alumina component;
ii) palladium supported on the one or more alumina component; and
iii) barium oxide;
wherein the second zone comprises:
i) one or more alumina component and one or more oxygen storage component;
ii) palladium supported on the one or more alumina component and the one or more oxygen storage component; and
iii) barium oxide.

13. The layered three-way catalyst composition according to claim 1, wherein, the first layer and the second layer both comprise a first zone and a second zone, p1 wherein the first zone of the first layer comprises:
i) one or more alumina component;
ii) palladium supported on the one or more alumina component; and
iii) barium oxide,
wherein the second zone of the first layer comprises:
i) one or more alumina component and one or more oxygen storage component;
ii) palladium supported on the one or more alumina component and the one or more oxygen storage component; and
iii) barium oxide,
wherein the first zone of the second layer comprises:
i) palladium supported on the one or more alumina component;
ii) rhodium supported on one or moreof the zirconia component and the alumina component; and
iii) the one or more of strontium oxide and barium oxide,
wherein the second zone of the second layer comprises:
i) palladium supported on one or more alumina component; and
ii) rhodium supported on the one or more of the zirconia component and the alumina component.

14. The layered three-way catalyst composition according to claim 11, wherein the composition further comprises a substrate, and the first zone, the second zone, or a combination thereof are deposited on the substrate.

15. A process for preparing the layered three-way catalyst composition according to claim 1, wherein the process comprises:
preparing a first layer;
optionally depositing the first layer on a substrate;
preparing a second layer; and
depositing the second layer on the first layer followed by calcination at a temperature ranging from 500° C. to 600° C.,
wherein the steps of preparing the first layer and the second layer comprise a technique chosen from incipient wetness impregnation technique(A); co-precipitation technique (B), and co-impregnation technique(C).

16. The process according to claim 15, wherein the incipient wetness impregnation technique (A) comprises:
i. loading barium oxide on the one or more alumina component and the one or more oxygen storage component to obtain a first mixture,
ii. calcining the first mixture to obtain a first calcined mixture,
iii. impregnating the first calcined mixture with palladium to obtain a first layer,
iv. loading strontium oxide or barium oxide on the one or more alumina component to obtain a second mixture,
v. subjecting the second mixture to calcination to obtain a second calcined mixture,
vi. impregnating the second calcined mixture with palladium to obtain a first material,
vii. loading strontium oxide and/or barium oxide on the one or more zirconia component to obtain a third mixture,
viii. calcining the third mixture to obtain a third calcined mixture,
ix. impregnating the third calcined mixture with rhodium to obtain a second material,
x. mixing the first material and the second material to obtain a second layer, and
xi. depositing the second layer on the first layer to obtain the layered three-way catalyst composition.

17. The process according to claim 15, wherein the co-precipitation technique (B) comprises:
i. incorporating barium oxide and palladium into the one or more alumina component and the one or more oxygen storage component by co-precipitation with one or more precursor of the alumina component and one or more precursor of the oxygen storage component to obtain a first mixture,
ii. calcining the first mixture to obtain a first layer,
iii. incorporating either of strontium oxide or barium oxide and palladium into the one or more alumina component by co-precipitation with one or more precursor of the alumina component to obtain a second mixture,
iv. calcining the second mixture to obtain a first material,
v. incorporating strontium oxide and/or barium oxide and rhodium into the one or more zirconia component by co-precipitation to obtain a third mixture,
vi. calcining the third mixture to obtain a second material,
vii. mixing the first material and the second material to obtain the second layer, and
viii. depositing the second layer on the first layer to obtain the layered three-way catalyst composition.

18. The process according to claim 15, wherein co-impregnation technique (B) comprises:
i. incorporating barium oxide or its precursor and palladium or its precursor into the one or more alumina component and the one or more oxygen storage component by co-impregnation to obtain a first mixture,
ii. calcining the first mixture to obtain a first layer,
iii. incorporating either of strontium oxide or its precursor or barium oxide or its precursor and palladium or its precursor into the one or more alumina component by co-impregnation to obtain a second mixture,
iv. calcining the second mixture to obtain a first material,
v. incorporating either of strontium oxide or its precursor and/or barium oxide or its precursor and rhodium or its precursor into the one or more zirconia component by co-impregnation to obtain a third mixture,
vi. calcining the third mixture to obtain a second material,
vii. mixing the first material and the second material to obtain the second layer, and
viii. depositing the second layer on the first layer to obtain the layered three-way catalyst composition.

19. The process according to claim 15, wherein the process further comprises steps of i) providing a substrate, ii) depositing the first layer on the substrate, and iii) depositing the second layer on the first layer.

20. The process according to claim 18, wherein the precursor of barium is chosen from barium nitrate, barium chloride, barium acetate, barium oxalate, barium aluminate, barium borate, barium fluoride, barium carbonate, barium hydroxide, barium sulfate, and barium sulphite;
wherein the precursor of strontium is chosen from strontium nitrate, strontium sulfate, strontium acetate, strontium chloride, and strontium oxalate; wherein the precursor of palladium is chosen from palladium chloride, palladium nitrate, and palladium acetate; and wherein the precursor of rhodium is chosen from rhodium chloride, rhodium nitrate, and rhodium acetate.

21. A method of treating a gaseous exhaust stream comprising hydrocarbons, carbon monoxide, and nitrogen oxide, the method comprising:
contacting the exhaust stream with the catalyst composition according to claim 1 or obtained by the process according to claim 15.

22. A method of reducing hydrocarbons, carbon monoxide, and nitrogen oxide levels in a gaseous exhaust stream comprising:
contacting the gaseous exhaust stream with a catalyst composition according to claim 1 or a catalyst composition obtained by the process according to claim 15 to reduce the levels of hydrocarbons, carbon monoxide, and nitrogen oxide in the exhaust gas.

23. The method according to claim 22, wherein the hydrocarbons, carbon monoxide, and nitrogen oxide levels present in the exhaust gas are reduced by at least 50% compared to the hydrocarbons, carbon monoxide, and nitrogen oxide levels in the exhaust gas stream prior to contact with the catalyst composition.

24. (canceled)

25. An exhaust system for internal combustion engines comprising the three-way catalyst composition according to claim 1 or obtained by the process according to claim 15, situated downstream from an internal combustion engine.
